(19) United States
(12) Patent Application Publication
(10) Pub. No.: US 2026/0210450 A1
(43) Pub. Date: Jul. 23, 2026

(54) ELECTRICALLY OPERATED VALVE

(71) Applicant: FUJIKOKI CORPORATION, Tokyo (JP)

(72) Inventor: Junya HAYAKAWA, Tokyo (JP)

(21) Appl. No.: 19/139,957

(22) PCT Filed: Jan. 29, 2024
(86) PCT No.: PCT/JP2024/002556

§ 371 Date: Jun. 17, 2025

(30) Foreign Application Priority Data
Feb. 17, 2023 (JP) 2023-023273

(51) Int. Cl. F16K 11/22; F16K 27/06; F16K 31/04; F16K 31/53

(52) U.S. Cl. CPC F16K 11/22; F16K 27/067; F16K 31/043; F16K 31/535

(57) ABSTRACT

An electrically operated valve is provided with a valve main body which has a first valve chamber and a second valve chamber in an inner part thereof, a first valve body which has a first valve body inner space in an inner part thereof and switches a flow passage for fluid by being rotationally driven within the first valve chamber, a second valve body which has a second valve body inner space in an inner part thereof and switches a flow passage for fluid by being rotationally driven within the second valve chamber, and a transmission mechanism which transmits a drive force for rotating the first valve body and the second valve body to the first valve body and the second valve body. Accordingly, the electrically operated valve can switch a plurality of flow passages such as a four-way valve and can be formed as a cartridge.

### TECHNICAL FIELD

The present invention relates to an electrically operated valve, and more particularly relates to a ball valve which can switch a flow passage on the basis of a rotational position of a valve body.

### BACKGROUND ART

In a refrigeration cycle apparatus such as a car air conditioner, a ball valve may be provided for switching a flow passage of a refrigerant. The ball valve is characterized in that a pressure loss is less and an operation time is short.

Further, in the refrigeration cycle apparatus as mentioned above, a cartridge type switching valve may be used. This can allow a switching valve (a valve main body) to be assembled in the refrigeration cycle apparatus only by inserting the switching valve into a valve mounting hole of a housing provided with an inflow passage and an outflow passage for the refrigerant such as a cartridge.

According to the cartridge type valve, for example, in a case where a manufacturer of the switching valve provides a product for a manufacturer of the refrigeration cycle apparatus corresponding to a customer thereof, the switching valve can be assembled in the refrigeration cycle apparatus to a finished product with a simple operation of only inserting the switching valve into the housing, as long as various specifications such as an outer size of the valve main body, positions of respective flow passage holes and the like are previously shared with both the valve manufacturer and the customer, and the housing is previously produced in the customer side as a part of the refrigeration cycle apparatus. Therefore, the customer can efficiently manufacture the refrigeration cycle apparatus. Further, even in a case where the switching valve is required to be exchanged at maintenance time, the exchanging work can be performed with the similar simple operation.

Further, the following patent literature 1 exists as a literature disclosing the ball valve.

### CITATION LIST

### Patent Literature

Patent Literature 1: U.S. Patent Application Publication No. 2021/0254728

### SUMMARY OF INVENTION

In the meantime, in the cartridge type valve, it is necessary to open flow passages (totally three flow passages including an inflow passage and two outflow passages connected to a valve in case of a three-way valve) to an inner part of a valve mounting hole into which the valve main body is inserted, and form the flow passages which are independent from each other so as to prevent the flow passages from communicating with each other in a short-circuit manner, thereby connecting to each of flow passage ports formed on an outer surface of the valve main body.

However, the valve body is transversely rotated in the conventional ball valve. Thus, the inflow passage is arranged, for example, on a bottom surface of the valve mounting hole, and can be sealed by placing a seal material (for example, O-ring) on an outer peripheral surface of the valve main body. However, two outflow passages switched by the rotation of the valve body have to be arranged around the transversely rotating valve body, that is, at different positions in a peripheral direction at the same height from the bottom surface of the inner peripheral surface of the valve mounting hole. Therefore, it is not easy to seal these two outflow passages in such a manner as to prevent from communicating with each other within the valve mounting hole. Accordingly, in the structure of the conventional ball valve, it was hard to realize the cartridge type switching valve.

Further, a ball valve capable of switching a plurality of flow passages such as a four-way valve can not be realized by the invention described in the patent literature 1 even if it is not of the cartridge type.

Therefore, an object of the present invention is to achieve a ball valve (electrically operated valve) which can switch a plurality of flow passages such as a four-way valve. Further, the other object of the present invention is to form the ball valve (electrically operated valve) capable of switching the plurality of flow passages as mentioned above as a cartridge.

In order to solve the problem and achieve the object, an electrically operated valve according to the present invention is provided with a valve main body which has a first valve chamber and a second valve chamber in an inner part thereof, a first valve body which has a first valve body inner space in an inner part thereof and switches a flow passage for fluid by being rotationally driven within the first valve chamber, a second valve body which has a second valve body inner space in an inner part thereof and switches a flow passage for fluid by being rotationally driven within the second valve chamber, and a transmission mechanism which transmits a drive force for rotating the first valve body and the second valve body to the first valve body and the second valve body.

Further, the valve main body has a first flow passage hole which allows a communication state with the first valve body inner space to be changed by a rotational displacement position of the first valve body, communicates with the first valve body inner space at a first rotational displacement position of the first valve body, and flows the fluid out of the first valve body inner space, a second flow passage hole which allows a communication state with the first valve body inner space to be changed by the rotational displacement position of the first valve body, and communicates with the first valve body inner space at a second rotational displacement position of the first valve body, a communication flow passage which communicates with the first valve body inner space, allows a communication state with the second valve body inner space to be changed by a rotational displacement position of the second valve body, communicates with the second valve body inner space at each of the first rotational displacement position and the second rotational displacement position of the second valve body, and allows the fluid to pass through between the first valve body inner space and the second valve body inner space, a third flow passage hole which allows a communication state with the second valve body inner space to be changed by the rotational displacement position of the second valve body, and communicates with the second valve body inner space at a third rotational displacement position of the second valve body, and a fourth flow passage hole which communicates with the second valve body inner space.

Typically, the above terms “first flow passage hole”, “second flow passage hole”, and “third flow passage hole” are all an outflow hole which flows the fluid out of the valve body inner space, and the above term “fourth flow passage hole” is an inflow hole which flows the fluid into the valve body inner space (second valve body inner space”.

However, the electrically operated valve according to the present invention can be used for flowing the fluid in an opposite direction (this use example is called as “second use mode”) to that in the typical use example (this use example is called as “first use mode”). In this second use mode, the above terms “first flow passage hole”, “second flow passage hole”, and “third flow passage hole” all come to an inflow hole which flows the fluid into the valve body inner space (first valve body inner space or second valve body inner space), and the above term “fourth flow passage hole” comes to an outflow hole which flow the fluid out of the valve body inner space (second valve body inner space).

Further, according to a preferable aspect of the present invention, the transmission mechanism may include a first valve body drive shaft which transmits a drive force driving the first body to the first valve body, and a second valve body drive shaft which transmits a drive force driving the second valve body to the second valve body, so that the drive force driving the second valve body is transmitted to the second valve body drive shaft via the first valve body drive shaft, and the first valve body and the second valve body simultaneously rotate in conjunction with each other.

In the electrically operated valve according to the present invention, the fluid flow passage is switched by two rotating valve bodies (first valve body and second valve body). For example (in a case of the first use mode), the fluid flowed into the valve main body (second valve chamber) from the fourth flow passage hole is flowed out of any of a plurality of flow passage holes (first flow passage hole, second flow passage hole and third flow passage hole). Each of the valve bodies switching the flow passages can rotationally drive by driving the drive force from one electric motor, for example, such as the preferable aspect mentioned above.

Each of the valve bodies has a space (valve body inner space) which allows the fluid to pass through an inner part thereof, and a switched state of the flow passage is changed by a communication state of the valve body inner space with respect to each of the flow passage holes and the communication flow passages.

More specifically, the second valve body inner space corresponding to the valve body inner space of the second valve body always communicates with the fourth flow passage hole, however, communicates with the communication flow passage communicating the second valve body and the first valve body at the first rotational displacement position and the second rotational displacement position of the second valve body. Further, the second valve body inner space communicates with the third flow passage hole at the third rotational displacement position of the second valve body.

On the contrary, the first valve body inner space corresponding to the valve body inner space of the first valve body always communicates with the communication flow passage, however, communicates with the first flow passage hole at the first rotational displacement position of the first valve body. Further, the first valve body inner space communicates with the second flow passage hole at the second rotational displacement position of the first valve body.

Therefore, in a case where the drive force is transmitted to the first valve body and the second valve body by the transmission mechanism such that the second valve body is at the first rotational displacement position when the first valve body is at the first rotational displacement position (this state is called as “first switched state”), and the second valve body is at the second rotational displacement position when the first valve body is at the second rotational displacement position (this state is called as “second switched state”), it is possible to form a flow passage reaching the second valve body inner space, the communication flow passage, the first valve body inner space and the first flow passage hole from the fourth flow passage hole by the first switched state, thereby allowing the fluid flowing into from the fourth flow passage hole to flow out of the first flow passage hole (case of the first use mode, the flow of fluid is inverted in a case of the second use mode, the same applies hereinafter).

Further, it is possible to form a flow passage reaching the second valve body inner space, the communication flow passage, the first valve body inner space and the second flow passage hole from the fourth flow passage hole by the second switched state, thereby allowing the fluid flowing into from the fourth flow passage hole to flow out of the second flow passage hole. Further, it is possible to form a flow passage reaching the second valve body inner space and the third flow passage hole from the fourth flow passage hole by driving such that the second valve body is at the third rotational displacement position (this state is called as “third switched state”), thereby allowing the fluid flowing into from the fourth flow passage hole to flow out of the third flow passage hole.

The interlocking motion of the first valve body and the second valve body as mentioned above can be achieved, for example, by appropriately setting a cooperation state between the first valve body drive shaft driving the first valve body and the second valve body drive shaft driving the second valve body, in other words, a transmission state of the drive force from the first valve body drive shaft to the second valve body drive shaft, more specifically, a gear ratio of a gear, for example, in a case where the gear is used as an engaging means (first engaging means and second engaging means) mentioned later.

Further, on the assumption that a parallel direction to an axial direction of the valve main body and an axis line of the valve main body is a vertical direction, and an orthogonal direction to the vertical direction is a horizontal direction, the present invention can employ as a typical aspect any one of an aspect in which the first valve body rotates around an axis line extending in the vertical direction, and the second valve body rotates around an axis line extending in the horizontal direction (this aspect is called as “first aspect), and an aspect in which the first valve body and the second valve body both rotate around the axis line extending in the horizontal direction (this aspect is called as “second aspect”). Details are as mentioned below. In the present invention, the rotation around the axis line extending in the vertical direction is called as “transverse rotation”, and the rotation around the axis line extending in the horizontal direction is called as “vertical rotation”, in each of the valve bodies. Further, advantages given by each of the aspects are collectively described in the description of the second aspect.

### First Aspect

According to the first aspect, the first valve body transversely rotates and the second valve body vertically rotates. In an electrically operated valve according to a preferable aspect of the present invention, the first valve body drive shaft and the axis of rotation of the first valve body both extend in the vertical direction, the second valve body drive shaft extends in the vertical direction, the axis of rotation of the second valve body extends in the horizontal direction, and the transmission mechanism includes a first engagement means which transmits the rotation of the first valve body drive shaft to the second valve body drive shaft, a second valve body driven shaft which extends in the horizontal direction, rotates by receiving a drive force transmitted from the second valve body drive shaft and transmits the rotation to the second valve body, and a second engagement means which transmits the rotation of the second valve body drive shaft to the second valve body driven shaft.

Further, in the first aspect mentioned above, the first engagement means may include a driving side spur gear which is disposed in the first valve body drive shaft, and a driven side spur gear which is disposed in the second valve body drive shaft and engages with the driving side spur gear, and the second engagement means may include a driving side bevel gear which is disposed in the second valve body drive shaft, and a driven side bevel gear which is disposed in the second valve body driven shaft and engages with the driving side bevel gear.

Further, in the first aspect mentioned above, the first flow passage hole may have a first inner opening which is an end part opening in the first valve chamber side, the second flow passage hole may have a second inner opening which is an end part opening in the first valve chamber side, the third flow passage hole may have a third inner opening which is an end part opening in the second valve chamber side, the fourth flow passage hole may have a fourth inner opening which is an end part opening in the second valve chamber side, the communication flow passage may have a fifth inner opening which is an end part opening in the first valve chamber side, and a sixth inner opening which is an end part opening In the second valve chamber side, an axis line of the fifth inner opening may coincide with an axis of rotation of the first valve body, the first inner opening may be formed in a first peripheral position around an axis line of the fifth inner opening, the second inner opening may be formed in a second peripheral position around the axis line of the fifth inner opening, the fourth inner opening may be formed in a side surface of the second valve chamber, an axis line of the fourth inner opening may coincide with an axis of rotation of the second valve body, the sixth inner opening may be formed in a first peripheral position around the axis line of the fourth inner opening, the third inner opening may be formed in a second peripheral position around the axis line of the fourth inner opening, the first valve body may have a first opening part which faces the fifth inner opening and communicates the communication flow passage and the first valve body inner space, and a second opening part which communicates the first flow passage hole and the second valve body inner space when facing the first inner opening, and communicates the second flow passage hole and the first valve body inner space when facing the second inner opening, in association with the rotation of the first valve body, the second valve body may have a third opening part which faces the fourth inner opening and communicates the fourth flow passage hole and the second valve body inner space, and a fourth opening part and a fifth opening part which communicate the communication flow passage and the second valve body inner space when facing the sixth inner opening and communicate the third passage hole and the second valve body inner space when facing the third inner opening, in association with the rotation of the second valve body.

### Second Aspect

According to the second aspect, the first valve body and the second valve body both vertically rotate. In an electrically operated valve according to a preferable aspect of the present invention, the first valve body drive shaft and the second valve body drive shaft both extend in the vertical direction, the axis of rotation of the first valve body and the axis of rotation of the second valve body both extend in the horizontal direction, and the transmission mechanism includes a first valve body driven shaft which extends in the horizontal direction, rotates by receiving a drive force transmitted from the first valve body drive shaft and transmits the rotation to the first valve body, a first engagement means which transmits the rotation of the first valve body drive shaft to the first valve body driven shaft, a second valve body driven shaft which extends in the horizontal direction, rotates by receiving a drive force transmitted from the second valve body drive shaft and transmits the rotation to the second valve body, and a second engagement means which transmits the rotation of the second valve body drive shaft to the second valve body driven shaft.

The second aspect has an advantage that forming a cartridge is easy. The second valve body is vertically rotated in the same manner as the first aspect. However, in the second aspect, the first valve body is vertically rotated. Thus, the opening in the first valve body side (the first valve chamber side) of the first passage hole and the opening in the first valve body side (the first valve chamber side) of the second flow passage hole can be divided in the vertical direction, and it is easy to form the openings in the valve body outer surface side (the fourth passage hole and the openings in the valve body outer surface side of each of the first to third flow passage holes) in such a manner as to divide in the vertical direction.

On the contrary, the first aspect has an advantage that the electrically operated valve (the valve part including the valve main body and the valve body) can be downsized in comparison with the second aspect. The first valve body is transversely rotated in the first aspect. Thus, the first flow passage hole and the second flow passage hole are formed, for example, only in such a manner as to extend to an outer peripheral surface of the valve main body horizontally from the first valve chamber, and the communication flow passage connecting the second valve body inner space and the first valve body inner space can be formed linearly in the vertical direction with a shortest distance. For example, by arranging the first valve body and the second valve body vertically side by side. As a result, it is not necessary to install the flow passage in the valve main body inner part in comparison with the first aspect (compare and refer to FIGS. 10 to 12 in a first embodiment and FIGS. 18 to 20 in a second embodiment mentioned later).

Further, in the second aspect mentioned above, the first engagement means may include a first driving side bevel gear which is disposed in the first valve body drive shaft, and a first driven side bevel gear which is disposed in the first valve body driven shaft and engages with the first driving side bevel gear, and the second engagement means may include a second driving side bevel gear which is disposed in the second valve body drive shaft, and a second driven side bevel gear which is disposed in the second valve body driven shaft and engages with the second driving side bevel gear.

Further, in the second aspect, on the assumption that one side of the vertical direction is upper, and the other side of the vertical direction is lower, the first flow passage hole may have a first inner opening which is an end part opening in the first valve chamber side, and a first outer opening which is an end part opening in an opposite side to the first valve chamber, the second flow passage hole may have a second inner opening which is an end part opening in the first valve chamber side, and a second outer opening which is an end part opening in an opposite side to the first valve chamber, the third flow passage hole may have a third inner opening which is an end part opening in the second valve chamber side, and a third outer opening which is an end part opening in an opposite side to the second valve chamber, the fourth flow passage hole may have a fourth inner opening which is an end part opening in the second valve chamber side, and a fourth outer opening which is an end part opening in an opposite side to the second valve chamber, the communication flow passage may have a fifth inner opening which is an end part opening in the first valve chamber side, and a sixth inner opening which is an end part opening in the second valve chamber side, an axis line of the fifth inner opening may coincide with an axis of rotation of the first valve body, the first inner opening may be formed in a first peripheral position around an axis line of the fifth inner opening, the second inner opening may be formed in a second peripheral position around the axis line of the fifth Inner opening, the fourth inner opening may be formed in a side surface of the second valve chamber, the axis line of the fourth inner opening may coincide with the axis of rotation of the second valve body, the sixth inner opening may be formed in a first peripheral position around the axis line of the fourth inner opening, the third inner opening may be formed in a second peripheral position around the axis line of the fourth inner opening, the fourth outer opening may be formed in an outer peripheral surface of the valve main body, the second outer opening may be formed at a position above the fourth outer opening in the outer peripheral surface of the valve main body, the first outer opening may be formed at a position above the second outer opening in the outer peripheral surface of the valve main body, the third outer opening may be formed in a bottom surface or an outer peripheral surface of the valve main body at a position below the fourth outer opening, the first valve body may have a first opening part which faces the fifth inner opening and communicates the communication flow passage and the first valve body inner space, and a second opening part which communicates the first flow passage hole and the first valve body inner space when facing the first inner opening, and communicates the second flow passage hole and the first valve body inner space when facing the second inner opening, in association with the rotation of the first valve body, and the second valve body may have a third opening part which faces the fourth inner opening and communicates the fourth flow passage hole and the second valve body inner space, and a fourth opening part and a fifth opening part which communicate the communication flow passage and the second valve body inner space when facing the sixth inner opening, and communicate the third flow passage hole and the second valve body inner space when facing the third inner opening, in association with the rotation of the second valve body.

Further, the following cartridge type electrically operated valve can be constructed on the basis of the second aspect mentioned above.

More specifically, the electrically operated valve is an electrically operated valve which can be mounted to a housing by inserting into a valve mounting hole of the housing provided with the valve mounting hole, a fourth flow passage which has an end part opening in an inner peripheral surface of the valve mounting hole, a first flow passage which has an end part opening at a position above the end part opening of the fourth flow passage in the inner peripheral surface of the valve mounting hole, a second flow passage which has an end part opening at a position above the end part opening of the fourth flow passage and below the end part opening of the first outflow passage in the inner peripheral surface of the valve mounting hole, and a third flow passage which has an end part opening at a position below the end part opening of the fourth flow passage in the inner peripheral surface of the valve mounting hole or in a bottom surface of the valve mounting hole. In this electrically operated valve, the first flow passage hole communicates with the first flow passage of the housing, the second flow passage hole communicates with the second flow passage of the housing, the third flow passage hole communicates with the third flow passage of the housing, and the fourth flow passage hole communicates with the fourth flow passage of the housing, when the valve main body is inserted into the valve mounting hole.

According to the present invention, it is possible to achieve the ball valve (electrically operated valve) which can switch a lot of flow passages such as the four-way valve. Further, it is possible to form the ball valve (electrically operated valve) capable of switching a lot of flow passages as mentioned above as a cartridge.

The other objects, features and advantages of the present invention are apparent from the following description of embodiments according to the present invention which is given on the basis of the accompanying drawings. It is apparent for a person skilled in the art that the present invention is not limited to the following embodiments, but can be variously changed within the scope of the invention described in claims. Further, in each of the drawings, same reference numerals denote the same or corresponding portions.

### BRIEF DESCRIPTION OF DRAWINGS

FIG. 1 is a perspective view showing an electrically operated valve according to a first embodiment of the present invention.

FIG. 2 is a perspective view showing the electrically operated valve (in a first switched state) according to the first embodiment in a state in which it is cut vertically by a surface including an up-and-down direction and a front-back direction (an illustration of an inner part of a driving apparatus is omitted).

FIG. 3 is a perspective view showing the electrically operated valve (in the first switched state) according to the first embodiment in a state in which it is cut vertically by a surface including the up-and-down direction and a lateral direction (the illustration of the inner part of the driving apparatus is omitted).

FIG. 4 is a vertical cross sectional view (cross section along a line B-B in FIG. 7) showing the electrically operated valve (in the first switched state) according to the first embodiment in a state in which it is cut vertically by the surface including the up-and-down direction and the front-back direction.

FIG. 5 is a perspective view showing a first valve body disposed in the electrically operated valve according to the first embodiment.

FIG. 6 is a perspective view showing a second valve body disposed in the electrically operated valve according to the first embodiment.

FIG. 7 is a vertical cross sectional view showing the electrically operated valve (in the first switched state) according to the first embodiment in a state in which it is cut vertically by a surface including the up-and-down direction and the lateral direction.

FIG. 8 is a vertical cross sectional view showing the electrically operated valve (in a second switched state) according to the first embodiment in a state in which it is cut vertically by the surface including the up-and-down direction and the lateral direction.

FIG. 9 is a vertical cross sectional view showing the electrically operated valve (in a third switched state) according to the first embodiment in a state in which it is cut vertically by the surface including the up-and-down direction and the lateral direction.

FIG. 10 is a vertical cross sectional view conceptually showing the first switched state of the electrically operated valve according to the first embodiment.

FIG. 11 is a vertical cross sectional view conceptually showing the second switched state of the electrically operated valve according to the first embodiment.

FIG. 12 is a vertical cross sectional view conceptually showing the third switched state of the electrically operated valve according to the first embodiment.

FIG. 13 is a perspective view showing an electrically operated valve (in a state in which it is mounted to a housing) according to a second embodiment of the present invention.

FIG. 14 is a perspective view showing the electrically operated valve (in a state in which it is not mounted to the housing) according to the second embodiment.

FIG. 15 is a perspective view showing the electrically operated valve (in a first switched state) according to the second embodiment in a state in which it is cut vertically by a surface including an up-and-down direction and a front-back direction (an illustration of an inner part of a driving apparatus is omitted).

FIG. 16 is a perspective view showing the electrically operated valve (in the first switched state) according to the second embodiment in a state in which it is cut vertically by a surface including the up-and-down direction and a lateral direction.

FIG. 17 is a perspective view showing a first valve body disposed in the electrically operated valve according to the second embodiment.

FIG. 18 is a vertical cross sectional view conceptually showing the first switched state of the electrically operated valve according to the second embodiment.

FIG. 19 is a vertical cross sectional view conceptually showing a second switched state of the electrically operated valve according to the second embodiment.

FIG. 20 is a vertical cross sectional view conceptually showing a third switched state of the electrically operated valve according to the second embodiment.

### DESCRIPTION OF EMBODIMENTS

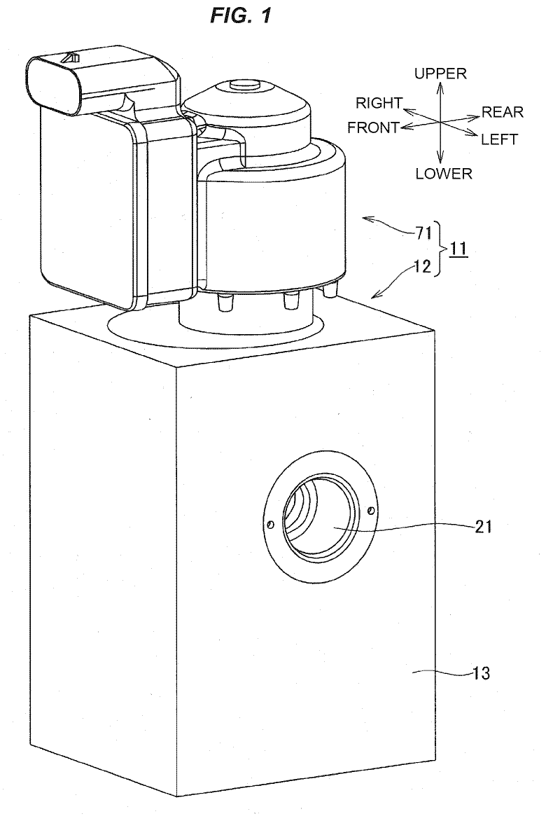

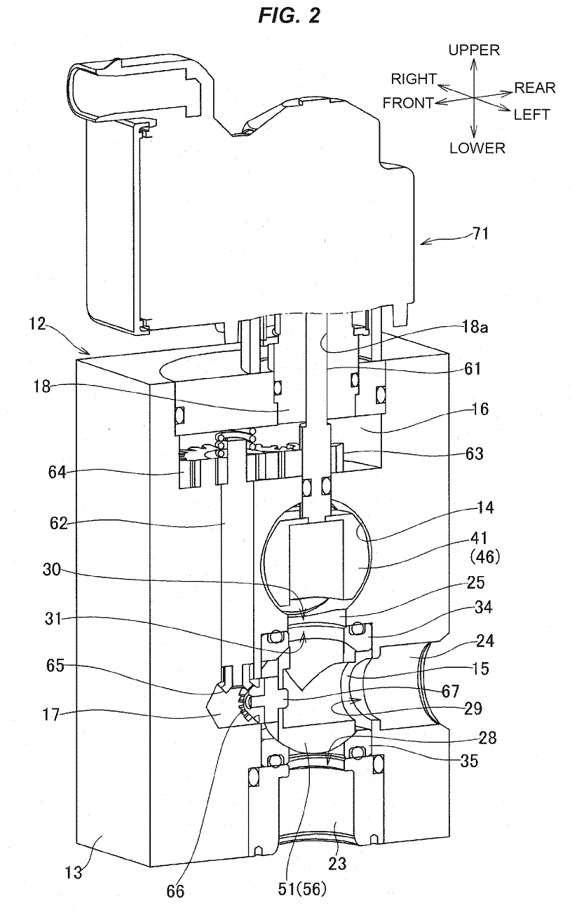

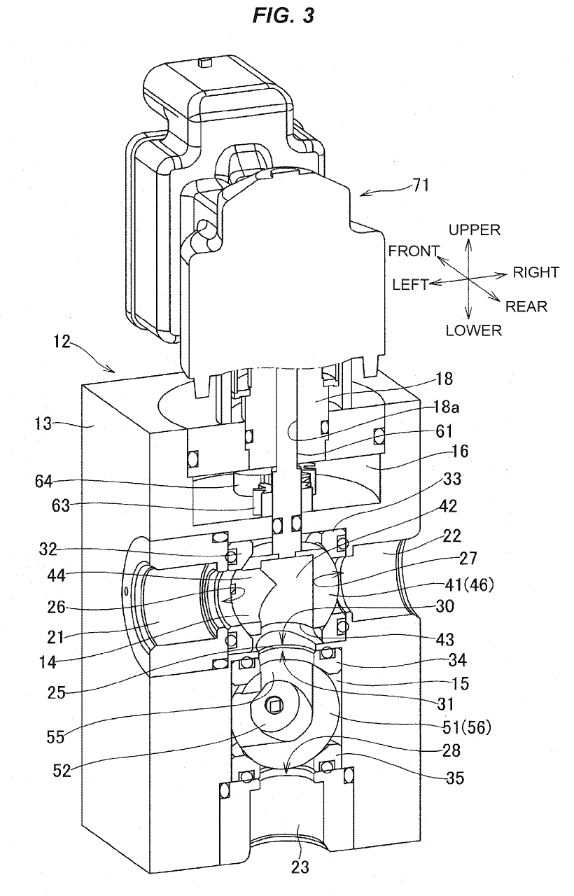

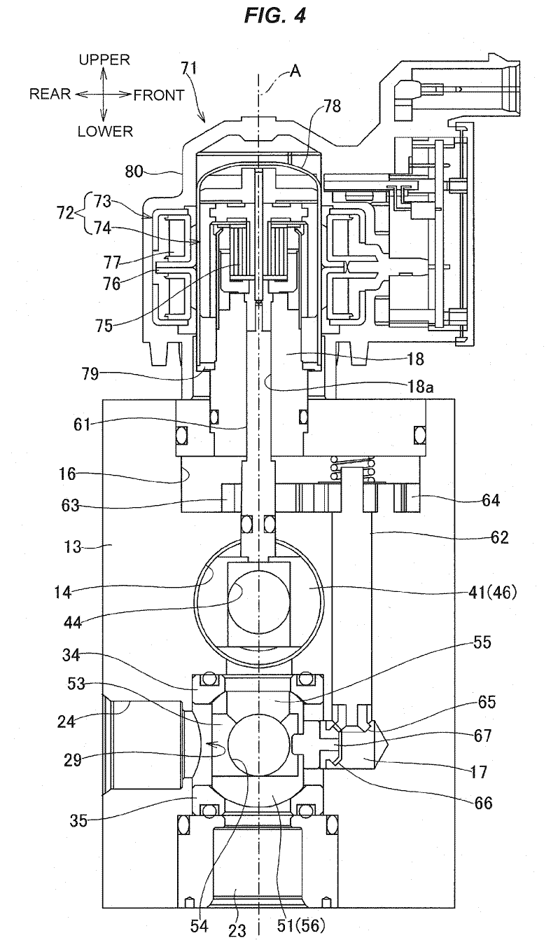

A description will be given of an electrically operated valve according to a first embodiment of the present invention with reference to FIGS. 1 to 12. The present embodiment is the electrically operated valve based on the first aspect mentioned above of the present invention. Further, each of the drawings appropriately shows two-dimensional coordinates or three-dimensional coordinates which represent an up-and-down direction, a front-back direction and a lateral direction and are orthogonal to each other, and the following description will be given on the basis of these directions. However, the electrically operated valve according to the present invention and the present embodiment (same applies to a second embodiment mentioned later) can be used in various directions, each of the directions are provided for convenience, and structures of respective parts of the present invention are not limited by these directions.

As shown in FIGS. 1 to 12, an electrically operated valve (which may be called simply as “valve”) 11 according to a first embodiment of the present invention is a four-way valve which allows a fluid flowed into from an inflow hole 24 to flow out of any of three outflow holes 21, 22 and 23, and can be used for switching a flow passage for refrigerant, for example, in a refrigeration cycle apparatus such as a heat pump type heating and cooling system.

More specifically, the electrically operated valve 11 is provided with a valve part 12 which switches the flow passage, a driving apparatus (an electric motor) 71 which generates a drive force (turning force) for driving the valve part 12, transmission mechanisms 61 to 67 which transmit the drive force generated by the driving apparatus 71 to the valve part 12 (valve bodies 41 and 51), and a connection member 18 which fixes the driving apparatus 71 to the valve part 12.

The valve part 12 has a valve main body 13 which has two valve chambers 14 and 15 (a first valve chamber 14 formed in an upper side and a second valve chamber 15 formed in a lower side) formed side by side in a vertical direction (an axial direction of the valve main body 13) in an inner part thereof, spherical valve bodies 41 and 51 (a first valve body 41 arranged in the first valve chamber 14 and a second valve body 51 arranged in the second valve chamber 15) which are arranged rotatably in the respective valve chambers 14 and 15, and valve seat members 32, 33, 34 and 35 which support each of the valve bodies 41 and 51 rotatably in each of the valve chambers 14 and 15.

The valve main body 13 has an inflow hole 24 (corresponding to “fourth flow passage hole” in the present invention) which allows the refrigerant to flow into, three outflow holes, that is, a first outflow hole 21 (corresponding to “first flow passage hole” in the present invention), a second outflow hole 22 (corresponding to “second flow passage hole” in the present invention) and a third outflow hole 23 (corresponding to “third flow passage hole” in the present invention) which allow the refrigerant to flow out, and a communication flow passage 25 which communicates two valve chambers 14 and 15.

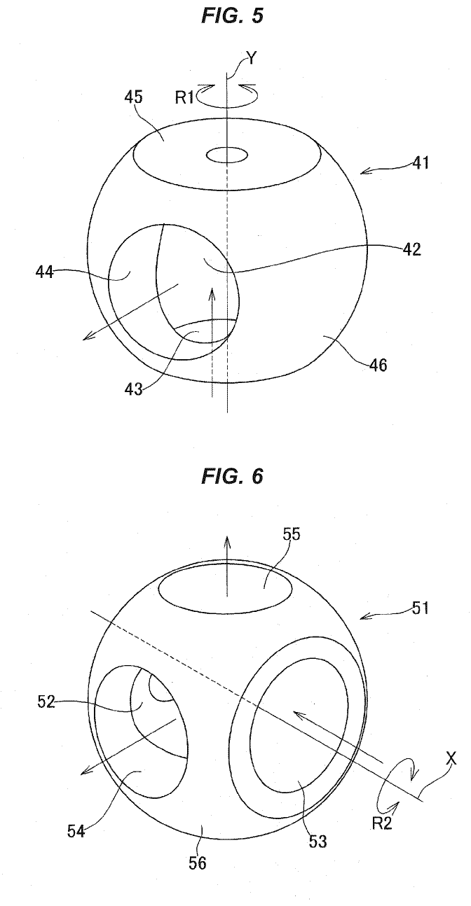

The respective valve bodies 41 and 51 have valve body inner spaces 42 and 52 (a first valve body inner space 42 and a second valve body inner space 52) which form the flow passages for allowing the fluid to pass through, shell wall parts 46 and 56 which form outer shells for covering the valve body inner spaces 42 and 52, and a plurality of opening parts 43, 44, 53, 54 and 55 which pass through the shell wall parts 46 and 56 and communicate with the valve body inner spaces 42 and 52. Describing in detail about each of the valve bodies 41 and 51, the first valve body 41 has a first opening part 43 which opens vertically downward, and a second opening part 44 which opens in a horizontal direction, and rotates (transversely rotates) around an axis line Y of the first opening part 43 extending in a vertical direction (refer to an arrow R1 in FIG. 5).

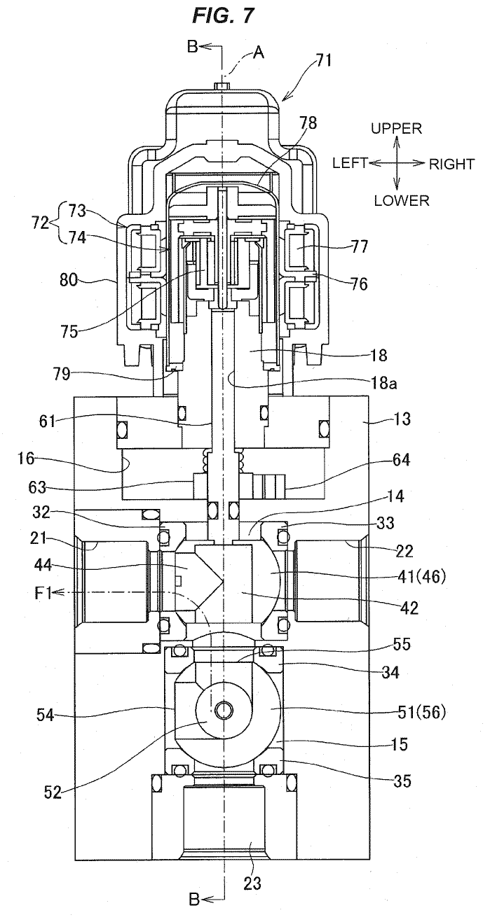

On the contrary, the second valve body 51 has a third opening part 53 which opens in a horizontal direction, and rotates (vertically rotates) around an axis line X of the third opening part 53 (refer to an arrow R2 in FIG. 6). Further, the second valve body 51 has a fourth opening part 54 and a fifth opening part 55 at different peripheral positions around the axis of rotation (the axis line of the third opening part) X, in addition to the third opening part 53. These fourth opening part 54 and the fifth opening part 55 open in such a manner that they form an angle of 90 degrees each other, in other words, so that the axis line of the fourth opening part 54 and the axis line of the fifth opening part 55 are orthogonal to each other.

On the other hand, the inflow hole 24 allowing the fluid to flow into the valve (the inner part of the valve main body 13) extends horizontally to the second valve chamber 15 from a rear side surface of the valve main body 13, and an opening (corresponding to a fourth inner opening of the first aspect, this opening is called hereinafter as “fourth inner opening”) 29 to the second valve chamber 15 faces the third opening part 53 of the second valve body 51. Therefore, the second valve body inner space 52 (the valve body inner space 52 of the second valve body 51) communicates with the inflow hole 24 through the third opening part 53 and the fourth inner opening 29, and this communication state is maintained even if the second valve body 51 rotates around the axis line X of the third opening part 53.

In the meantime, the first outflow hole 21 allowing the fluid to flow out of the valve (outer part of the valve main body 13) extends horizontally to the first valve chamber 14 from a left side surface of the valve main body 13, and opens to the first valve chamber 14 (this opening 26 corresponds to the first inner opening of the first aspect, and this opening 26 is hereinafter called as “first inner opening”). Further, in the same manner, the second outflow hole 22 allowing the fluid to flow out of the valve extends horizontally to the first valve chamber 14 from a right side surface of the valve main body 13, and opens to the first valve chamber 14 (this opening 27 corresponds to the second inner opening of the first aspect, and this opening 27 is hereinafter called as “second inner opening”). More specifically, the first inner opening 26 and the second inner opening 27 open to the first valve chamber 14 in such a manner as to form an angle of 180 degrees each other at different peripheral positions around the axis of rotation of the first body 41 (the axis line of the first opening part 43) Y (in other words, so that the axis line of the first inner opening 26 coincides with the axis line of the second inner opening 27).

The second opening part 44 of the first valve body 41 faces the first inner opening 26 or the second inner opening 27 according to a rotating state (a rotational displacement position) of the first valve body 41, and the first valve body inner space 42 (the valve body inner space 42 of the first valve body 41) communicates with the first outflow hole 21 when the second opening part 44 faces the first inner opening 26. Further, at this time, the second inner opening 27 is closed by the shell wall part 46 of the first valve body 41. On the contrary, when the second opening part 44 faces the second inner opening 27, the first valve body inner space 42 communicates with the second outflow hole 22. At this time, the first inner opening 26 is closed by the shell wall part 46 of the first valve body 41.

The communication flow passage 25 communicating the first valve chamber 14 and the second valve chamber 15 extends in the vertical direction in such a manner as to connect the first valve chamber 14 and the second valve chamber 15, an opening 30 in the first valve chamber 14 side (this opening 30 corresponds to the fifth inner opening of the first aspect, and this opening is hereinafter called as “fifth inner opening”) faces the first opening part 43 of the first valve body 41, and an axis line of the fifth inner opening 30 coincides with the axis of rotation Y of the first valve body 41 (the axis line Y of the first opening part 43). Therefore, the first valve body inner space 42 communicates with the communication flow passage 25 via the first opening part 43 and the fifth inner opening 30, and this communication state is maintained even if the first valve body 41 rotates around the axis line Y of the first opening part 43.

In the meantime, an opening 31 in the second valve chamber 15 side of the communication flow passage 25 (this opening 31 corresponds to the sixth inner opening of the first aspect, and this opening is hereinafter called as “sixth inner opening) is formed at a peripheral position around the axis of rotation X of the second valve body 51 (the axis line of the fourth inner opening 29) (in a top surface part of the second valve chamber in the present embodiment). Further, the third outflow hole 23 allowing the fluid to flow out of the valve extents vertically to the second valve chamber 15 from a bottom surface (a lower surface) of the valve main body 13. An opening 28 in the second valve chamber 15 side of the third outflow hole 23 (this opening 28 corresponds to the third inner opening of the first aspect, and this opening is hereinafter called as “third inner opening”) is formed at a different peripheral position from the sixth inner opening 31 around the axis of rotation X of the second valve body 51 (the axis line of the fourth inner opening 29) (in a bottom surface part of the second valve chamber 15 in the present embodiment).

The fourth opening part 54 and the fifth opening part 55 of the second valve body 51 face the sixth inner opening 31 or the third inner opening 28 according to the rotating state (the rotational displacement position) of the second valve body 51, and the second valve body inner space 52 (the valve body inner space 52 of the second valve body 51) communicates with the communication flow passage 25 when any one of the fourth opening part 54 and the fifth opening part 55 faces the sixth inner opening 31. Further, at this time, the third inner opening 28 is closed by the shell wall part 56 of the second valve body 51. On the contrary, when any one of the fourth opening part 54 and the fifth opening part 55 faces the third inner opening 28, the second valve body inner space 52 communicates with the third outflow hole 23. Further, at this time, the sixth inner opening 31 is closed by the shell wall part 56 of the second valve body 51.

The second valve body inner space 52 does not simultaneously communicate with both the sixth inner opening 31 and the third inner opening 28 in spite of the provision of two opening parts 54 and 55 around the axis of rotation X in the second valve body 51 because the angle formed by the sixth inner opening 31 and the third inner opening 28 is differentiated from the angle formed by the fourth opening part 54 and the fifth opening part 55 around the axis of rotation Y of the second valve body 51 (the sixth inner opening 31 and the third inner opening 28 are formed in such a manner as to form the angle of 180 degrees each other around the axis of rotation Y of the second valve body 51, but the fourth opening part 54 and the fifth opening part 55 of the second valve body 51 are formed in such a manner as to form the angle of 90 degrees each other around the axis of rotation Y of the second valve body 51).

The valve seat members 32 to 35 are constructed by a pair of valve seat members (a left valve seat member 32 and a right valve seat member 33) which are placed in the first valve chamber 14 with facing each other in the lateral direction in such a manner as to rotatably clamp the first valve body 51 laterally for the transversely rotating first valve body 41, and are constructed by a pair of valve seat members (an upper valve seat member 34 and a lower valve seat member 35) which are placed in the second valve chamber 15 with facing each other in the up-and-down direction in such a manner as to rotatably clamp the second valve body 51 vertically for the vertically rotating second valve body 51. Further, each of the valve seat members 32 to 35 has a through hole which allows the flow passage holes 21 to 23 and the communication flow passage 25 to communicate with the valve chambers 14 and 15 (the valve body inner spaces 42 and 52), and is provided in a valve body side of the through hole (near side of center parts of the valve chambers 14 and 15) with a valve seat which rotates with contacting with the valve bodies 41 and 51. Each of the valve bodies 41 and 51 rotates (slidably rotates) while contacting with the valve seat.

The transmission mechanism transmitting the drive force to the first valve body 41 and the second valve body 51 has a first valve body drive shaft 61, a driving side spur gear 63, a driven side spur gear 64, a second valve body drive shaft 62, a driving side bevel gear 65, a driven side bevel gear 66, and a second valve body driven shaft 67.

The first valve body drive shaft 61 is configured to transmit the drive force of the driving apparatus 71 to the first valve body 41 and transmit it to the second valve body drive shaft 62, and is disposed in such a manner as to vertically extend between the driving apparatus 71 fixed to the upper surface part of the valve main body 13 by the connection member 18 and the valve main body 13, and is rotatably supported within a guide hole 18a passing through the connection member vertically. Further, an upper end part of the first valve body drive shaft 61 is connected to a rotor 74 (mentioned later) within the driving apparatus 71 via a speed reduction mechanism 75 (mentioned later), and a lower end part thereof is connected to a top surface part 45 of the first valve body 41 arranged within the first valve chamber 14. An axis of rotation A of the first valve body drive shaft 61 coincides with an axis of rotation of the rotor 74 and the axis of rotation Y of the first valve body 41.

Further, in order to transmit the drive force to the second valve body drive shaft 62, the driving side spur gear 63 is disposed in an intermediate part of the first valve body drive shaft 61. This driving side spur gear 63 is accommodated in a first gear chamber 16 which is formed in an upper part of the valve main body 13 together with the driven side spur gear 64.

The second valve body drive shaft 62 is configured to transmit the drive force transmitted from the driving apparatus 71 via the first valve body drive shaft 61 to the second valve body 51, and is arranged in such a manner as to vertically extend in a valve main body inner part in a front side of the first valve chamber 14 and the second valve chamber 15. Further, the second valve body drive shaft 62 is provided in an upper end part with the driven side spur gear 64 which engages with the driving side spur gear 63 fixed to the first valve body drive shaft 61, and is provided in a lower end part with the driving side bevel gear 65. The driving side bevel gear 65 is accommodated in a second gear chamber 17 which is formed in a lower part of the valve main body 13 together with the driven side bevel gear 66.

The driven side bevel gear 66 engages with the driving side bevel gear 65 and is configured to transmit the rotation of the second valve body drive shaft 62 to the second valve body 51 via the second valve body driven shaft 67. The second valve body driven shaft 67 extends in a horizontal direction in a lower part of the valve main body, and is provided in one end (front end) with the driven side bevel gear 66, and is connected in the other end (rear end) thereof to the second valve body 51, in more detail, to the shell wall part 56 in a front side of the second valve body 51 which is an opposite side to the third opening part 53 formed in a rear side of the second valve body 51.

According to the transmission mechanisms 61 to 67 as mentioned above, when the first valve body drive shaft 61 rotates, the driving side spur gear 63 and the driven side spur gear 64 engaging with the driving side spur gear 63 rotate at the same time that the first valve body 41 transversely rotates. As a result, the second valve body drive shaft 62 rotates, and this rotation is transmitted to the second valve body driven shaft 67 via the driving side bevel gear 65 and the driven side bevel gear 66, so that the second valve body 51 vertically rotates. The driving side spur gear 63 and the driven side spur gear 64 transmitting the rotation of the first valve body drive shaft 61 to the second valve body drive shaft 62 correspond to “first engagement means” according to the first aspect of the present invention, and the driving side bevel gear 65 and the driven side bevel gear 66 transmitting the rotation of the second valve body drive shaft 62 to the second valve body driven shaft 67 correspond to “second engagement means” according to the first aspect of the present invention.

Further, each of the gear ratios of the first engagement means (the driving side spur gear 63 and the driven side spur gear 64) and the second engagement means (the driving side bevel gear 65 and the driven side bevel gear 66) is set such that the rotating speed of the second valve body 51 comes to one half of the rotating speed of the first valve body 41. Therefore, the second valve body 51 rotates at 90 degrees when the first valve body 41 rotates at 180 degrees.

The driving apparatus 71 includes a stepping motor 72, and a speed reduction mechanism 75 which reduces the rotation of the stepping motor 72 and transmits to the transmission mechanisms 61 to 67. For this purpose, a can (a sealed container) 78 forming a sealed space is disposed in an upper surface part of the connection member 18. The can 78 is a cylindrical member which is covered and not bottomed (is opened in a bottom surface and is closed in a top surface), and is fixed to an outer peripheral surface of the connection member 18 via a ring-shaped base member 79.

The stepping motor 72 is constructed by a stator 73 which is placed in an outer side (an outer periphery) of the can 78, and a rotor 74 which is rotatably placed in an inner side (an inner periphery) of the can 78.

The stator 73 includes a yoke 76, a coil 77 which is formed by winding a winding wire to a bobbin, and a resin molded cover 80 which covers the yoke 76 and the coil 77. On the contrary, the rotor 74 is provided in an inner side thereof with a paradox planetary gear speed reduction mechanism which has a high deceleration and is effective for downsizing, as the speed reduction mechanism 75 mentioned above. The first valve body drive shaft 61 is connected to the rotor 74 via the speed reduction mechanism 75 as mentioned above, and the rotation of the rotor 74 is reduced by the speed reduction mechanism 75 and is transmitted to the first valve body drive shaft 61.

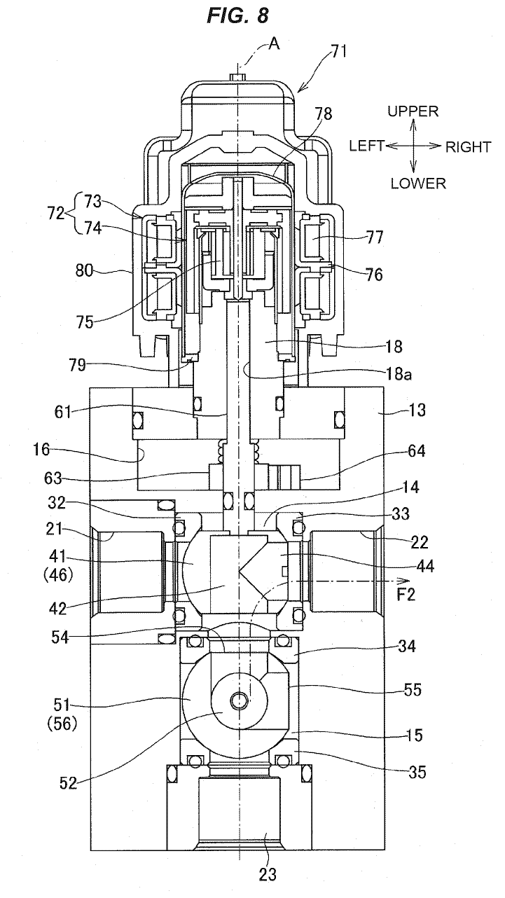

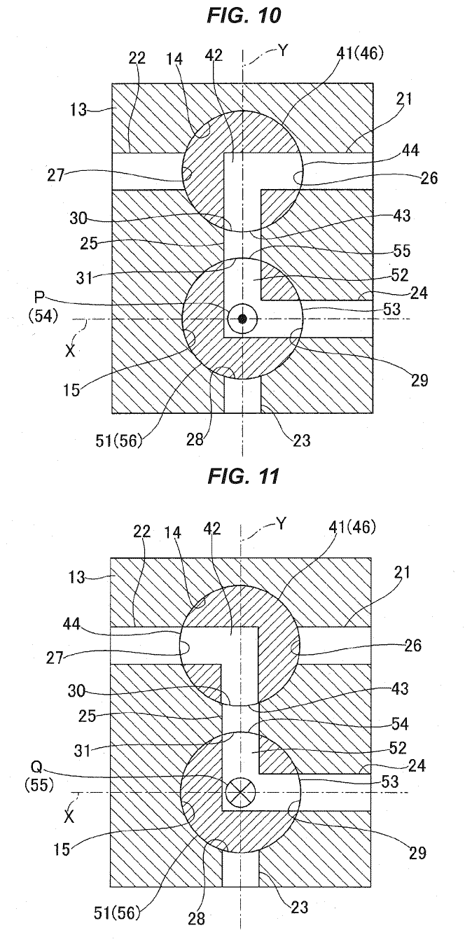

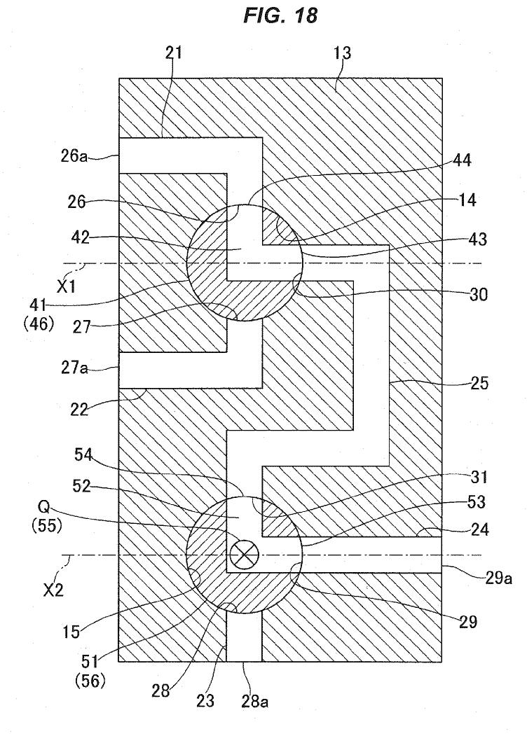

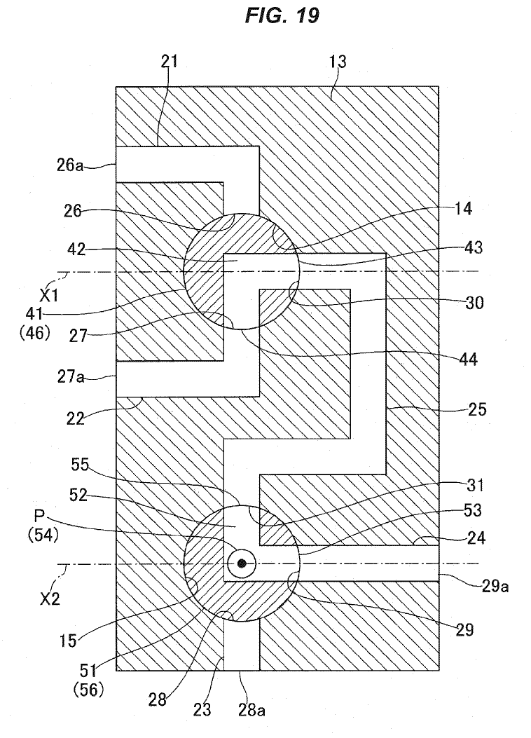

A description will be given of a motion of the electrically operated valve 11 according to the present embodiment on the basis of FIGS. 7 to 12. In the present embodiment, the axis lines of the first inner opening 26 (the first outflow hole 21) and the second inner opening 27 (the second outflow hole 22) are orthogonal to the axis line of the fourth inner opening 29 as already described. However, for convenience of illustration (in order to easily understand conceptually), in FIGS. 10 to 12 conceptually showing the electrically operated valve 11 according to the present embodiment, the axis lines of the first inner opening 26 and the second inner opening 27 are expressed in the drawings to be parallel to the axis line X of the fourth inner opening 29. Further, reference sign P in FIGS. 10 to 12 indicates that the opening part (the fourth opening part 54 or the fifth opening part 55) of the second valve body 51 extends toward a front side of the plane of paper), and reference sign Q indicates that the opening part (the fourth opening part 54 or the fifth opening part 55) of the second valve body 51 extends toward a back side of the plane of paper (same applies to FIGS. 18 to 20 according to a second embodiment mentioned later).

### [First Switched State]

In a first switched state shown in FIGS. 7 to 10, the fifth opening part 55 of the second valve body 51 faces the sixth inner opening 31 of the communication flow passage 25, and the second opening part 44 of the first valve body 41 faces the first inner opening 26 of the first outflow hole 21. At this time, the third inner opening 28 of the second valve chamber 15 (the third outflow hole 23) is closed by the shell wall part 56 of the second valve body 51, and the second inner opening 27 of the first valve chamber 14 (the second outflow hole 22) is closed by the shell wall part 46 of the first valve body 41. As already mentioned, the third opening part 53 of the second valve body 51 always faces the inflow hole 24 (the fourth inner opening 29), and the first opening part 43 of the first valve body 41 always faces the fifth inner opening 30 of the communication flow passage 25.

Therefore, in this first switched state, the refrigerant flowing into the second valve chamber 15 from the inflow hole 24 flows into the second valve body inner space 52 through the third opening part 53, and flows out to the communication flow passage 25 from the second valve body inner space 52 through the fifth opening part 55 and the sixth inner opening 31 to flow upward in the communication flow passage 25. Further, the refrigerant flows into the first valve body inner space 42 through the fifth inner opening 30 of the communication flow passage 25 and the first opening part 43 of the first valve body 41, thereafter flows out to the first outflow hole 21 through the second opening part 44, and flow out of the valve through the first outflow hole 21 (refer to an arrow F1 in FIG. 7).

### [Second Switched State]

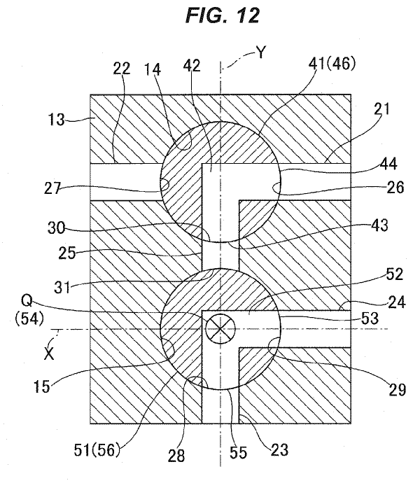

A second switched state shown in FIGS. 8 and 11 is a state in which the first valve body drive shaft 61 is rotated by the driving apparatus 71 from the first switched state, and the first valve body 41 is transversely rotated at 180 degrees. When the first valve body 41 transversely rotates at 180 degrees, the second valve body 51 vertically rotates at 90 degrees.

In this second switched state, the fourth opening part 54 of the second valve body 51 faces the sixth inner opening 31 of the communication flow passage 25, and the second opening part 44 of the first valve body 41 faces the second inner opening 27 of the second outflow hole 22. At this time, the third inner opening 28 of the second valve chamber 15 (the third outflow hole 23) is closed by the shell wall part 56 of the second valve body 51, and the first inner opening 26 of the first valve chamber 14 (the first outflow hole 21) is closed by the shell wall part 46 of the first valve body 41.

Therefore, in this second switched state, the refrigerant flowing into the second valve chamber 15 from the inflow hole 24 flows into the second valve body inner space 52 through the third opening part 53, and flows out to the communication flow passage 25 from the second valve body inner space 52 through the fourth opening part 54 and the sixth inner opening 31 to flow upward in the communication flow passage 25. Then, the refrigerant flows into the first valve body inner space 42 through the fifth inner opening 30 of the communication flow passage 25 and the first opening part 43 of the first valve body 41, thereafter flow out to the second outflow hole 22 through the second opening part 44, and flows out of the valve through the second outflow hole 22 (refer to an arrow F2 in FIG. 8).

### [Third Switched State]

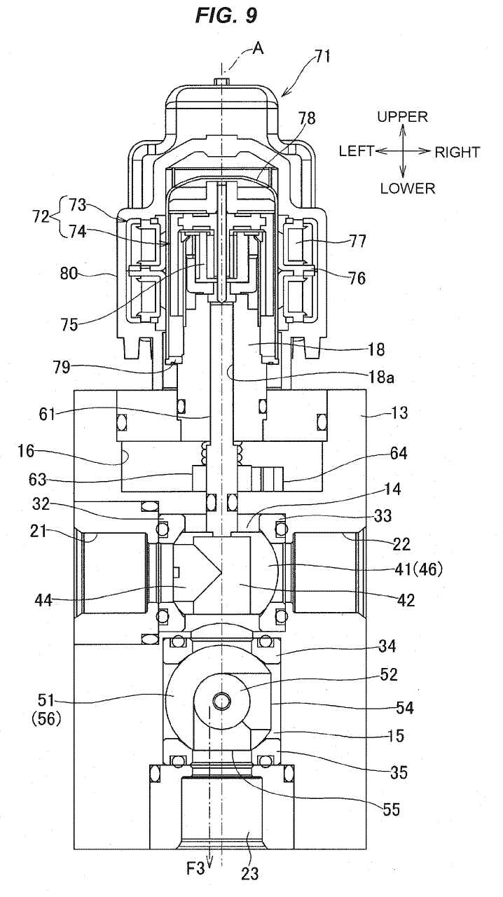

A third switched state shown in FIGS. 9 and 12 is a state in which the first valve body drive shaft 61 is further rotated in the same direction by the driving apparatus 71 from the second switched state mentioned above, and the first valve body is transversely rotated at 180 degrees. When the first valve body 41 transversely rotates at 180 degrees, the second valve body 51 vertically rotates at 90 degrees.

In this third switched state, the fifth opening part 55 of the second valve body 51 faces the third inner opening 28 of the third outflow hole 23. The second opening part 44 of the first valve body 41 faces the first inner opening 26 of the first outflow hole 21, but the sixth inner opening 31 of the second valve chamber 15 (the communication flow passage 25) is closed by the shell wall part 56 of the second valve body 51. Therefore, the refrigerant does not flow to the first valve chamber 14 (the communication flow passage 25).

Accordingly, in this third switched state, the refrigerant flowing into the second valve chamber 15 from the inflow hole 24 flows into the second valve body inner space 52 through the third opening part 53, and thereafter flows out to the valve from the third outflow hole 23 through the third inner opening 28 in the bottom surface of the second valve chamber 15 (refer to an arrow F3 in FIG. 9).

Further, it is possible to return to the second switched state by reverse rotating the first valve body drive shaft 61 (the stepping motor 72) from the third switched state and transversely rotating the first valve body 41 inversely at 180 degrees, and it is possible to return to the first switched state by reverse rotating the first valve body drive shaft 61 (the stepping motor 72) from the second switched state and transversely rotating the first valve body 41 inversely at 180 degrees.

The electrically operated valve 11 according to the present embodiment is provided with a Hall element which detects an angle of rotation of the rotor 74 included in the driving apparatus 71, and can detect a rotational displacement position (angle of rotation) of the first valve body 41 by detecting the angle of rotation of the rotor 74 (can accordingly detect the second valve body 51 interlocking with the first valve body 41), and can switch the flow passage as mentioned above. Further, the motion and the function of the valve bodies 41 and 51 as mentioned above can be realized as long as a shape around the axis of rotation X and Y of each of the valve bodies 41 and 51 is circular. Therefore, the valve bodies 41 and 51 are not necessarily formed into a complete spherical body, but may be formed into “spherical shape”. The term “spherical shape” includes a prolate spheroid (spheroid) and a cylindrical shape.

Further, in a case where a slit along a rotating direction is provided on the outer peripheral surfaces of the valve bodies 41 and 51, a gap is generated by the slit between the valve bodies 41 and 51 and the valve seat (the valve seat members 32 to 35). Therefore, it is possible to flow at a predetermined flow rate over a predetermined angle range of rotation (a predetermined angle range). The predetermined angle range is an angle corresponding to a length of the slit in the rotating direction, and the predetermined flow rate is a flow rate corresponding to a width of the slit. It is possible to improve a degree of freedom for controlling the flow rate by changing the shape of the slit. Further, the structure employing the valve body with slit can be used, for example, as an expansion valve.

### Second Embodiment

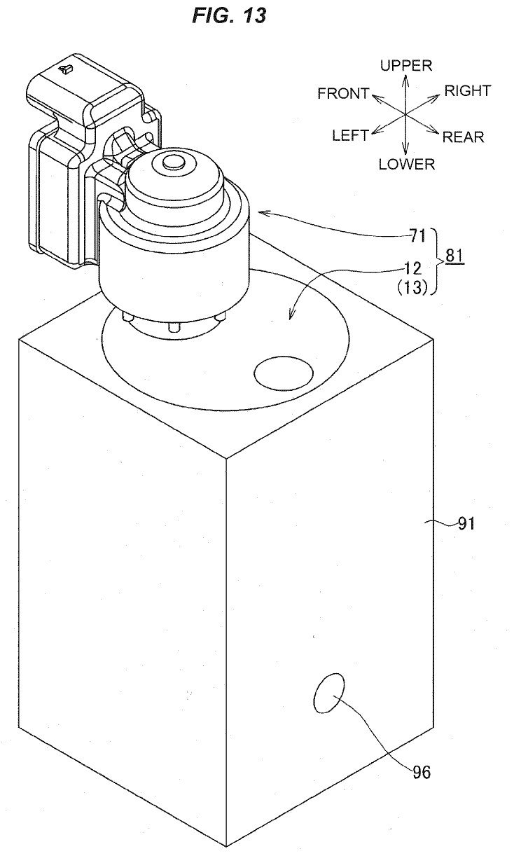

A description will be given of an electrically operated valve according to a second embodiment of the present invention with reference to FIGS. 13 to 20. The electrically operated valve according to the present embodiment is based on the second aspect of the present invention. Further, the same reference numerals are attached to the same or corresponding portions to those of the first embodiment, an overlapping description will be omitted, and the description will be given with a focus on different points.

As shown in FIGS. 13 to 20, the electrically operated valve 81 according to the second embodiment of the present invention is a cartridge type electrically operated valve which can be assembled in a refrigeration cycle apparatus by being inserted into a valve mounting hole 92 of a housing 91, and is the same as the first embodiment in a point that the second valve body 51 is vertically rotated (in the structure of the second valve body 51 and the mechanisms 62 and 65 to 67), and is different from the first embodiment in a point that the first valve body 41 is also vertically rotated.

Thus, in the present embodiment, the driving apparatus 71 is arranged forward in comparison with the first embodiment, and the first valve body drive shaft 61 connected to the driving apparatus 71 and extending to the inner part of the valve main body 13 from the driving apparatus 71 is configured to be arranged in a front side of the first valve chamber 14 and the second valve chamber 15 in the same manner as the second valve body drive shaft 62. Further, the rotation of the first valve body drive shaft 61 is transmitted to the second valve body drive shaft 62 by directly connecting the lower end part of the first valve body drive shaft 61 to the upper end part of the second valve body drive shaft 62 (without using a gear in the first embodiment).

Further, the communication flow passage 25 extends upward from the sixth inner opening 31 formed in the top surface part of the second valve chamber 15 in the same manner as the first embodiment, however, is bent horizontally rearward at a lower position of the first valve chamber 14 in the present embodiment and is configured to be installed in a rear side of the first valve chamber 14 and be communicated horizontally to the first valve chamber 14 from the rear side of the first valve chamber 14. Therefore, the fifth inner opening 30 corresponding to the opening for the first valve chamber 14 of the communication flow passage 25 is formed in a rear surface of the first valve chamber 14.

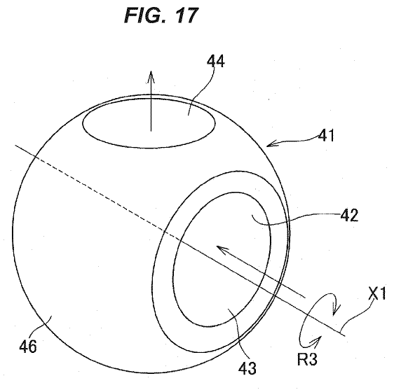

In the present embodiment, the first valve body 41 has a first opening part 43 which is open horizontally so as to face the fifth inner opening 30 and always communicates the communication flow passage 25 and the first valve body inner space 42 regardless of a rotating state, and a second opening part 44 which is open to a peripheral position around an axis line X1 of the first opening part 43 extending in the horizontal direction (which is also an axis line of the fifth inner opening 30), and rotates (vertically rotates) around the axis line X1 of the first opening part 43 (refer to an arrow R3 in FIG. 17). The second valve body 51 has the same structure as the first embodiment (FIG. 6).

Further, in the present embodiment, the first inner opening 26 is formed in the top surface of the first valve chamber 14, and the second inner opening 27 is formed in the bottom surface part of the first valve chamber 14 in such a manner that the first inner opening 26 corresponding to the opening in the first valve chamber 14 side of the first outflow hole 21 and the second inner opening 27 corresponding to the opening in the first valve chamber 14 side of the second outflow hole 22 form an angle of 180 degrees each other around the axis of rotation X1 of the first valve body 41.

Further, the first outflow hole 21 extends vertically upward from the first inner opening 26, and is bent at a right angle in the upper part of the first valve chamber 14, thereafter extends horizontally rightward, and is open as a first outer opening 26a to a right outer peripheral surface of the valve main body 13. Further, the second outflow hole 22 extends vertically downward from the second inner opening 27, and is bent at a right angle in the lower part of the first valve chamber 14, thereafter extends horizontally rightward, and is open as a second outer opening 27a to a right outer peripheral surface of the valve main body 13. Further, the third outflow hole 23 and the inflow hole 24 are the same as the first embodiment, and the third outflow hole 23 extends vertically downward from the third inner opening 28 in the bottom surface of the second valve chamber, and is open as a third outer opening 28a to the bottom surface of the valve main body. Further, the inflow hole 24 extends horizontally rearward from the fourth inner opening 29 in the rear side surface of the second valve chamber 15, and is open as a fourth outer opening 29a to the rear outer peripheral surface of the valve main body 13.

In the present embodiment, as a different feature from the first embodiment, the outer openings (the first outer opening 26a, the second outer opening 27a, the third outer opening 28a and the fourth outer opening 29a) corresponding to the outer openings of the respective flow passage holes (the inflow hole 24 and the outflow holes 21 to 23) are formed at different positions in the up-and-down direction (which is the axial direction of the valve main body 13 and is also the depth direction of the valve mounting hole 92 of the housing 91). More specifically, the outer opening (the first outer opening) 26a of the first outflow hole 21 is at the topmost position, the outer opening (the second outer opening) 27a of the second outflow hole 22 is below the first outer opening 26a, the outer opening (the fourth outer opening) 29a of the inflow hole 24 is below the second outer opening 27a, and the outer opening (the third outer opening) 28a of the third outflow hole 23 is at the bottommost position (below the fourth outer opening 29a).

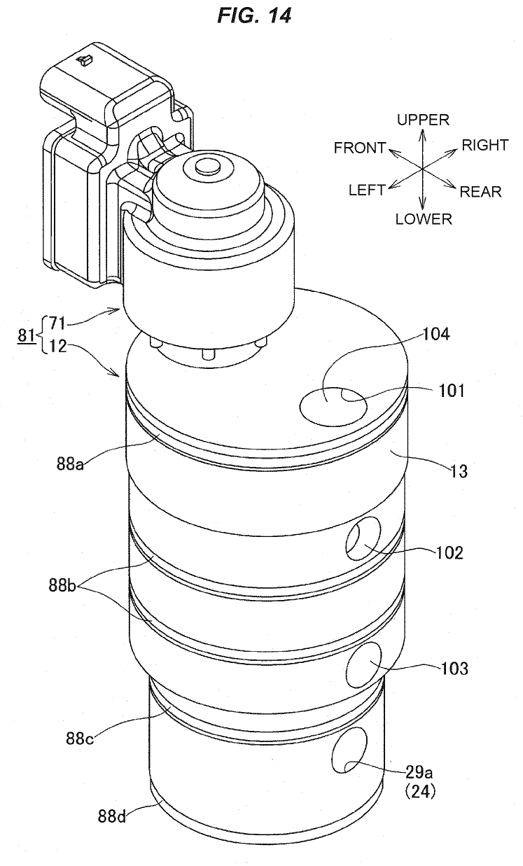

Therefore, each of the flow passages 21 to 24 can be separated in the up-and-down direction by the provision of seal materials (for example, O-rings) 84 (84a, 84b, 84c and 84d) surrounding the outer peripheral surface of the valve main body 13 in such a manner as to be interposed between the outer openings 26a to 29a (and between the valve main body 13, and the upper surface of the housing 91 and the first outer opening 26a). Each of the seal materials 84a, 84b, 84c and 84d is interposed between the outer peripheral surface of the valve main body 13 and the inner peripheral surface of the valve mounting hole 92. As a result, a plurality of ring-shaped sealed spaces separated in the up-and-down direction are formed between the valve mounting hole 92 and the valve main body 13 inserted thereto, and the cartridge type electrically operated valve can be achieved by utilizing each of the spaces as an independent (mutually blocked) flow passage. The seal materials 84a, 84b, 84c and 84d may be placed in such a manner as to be respectively fitted into grooves 88a, 88b, 88c and 88d (refer to FIG. 14) horizontally extending so as to surround the outer peripheral surface of the valve main body 13.

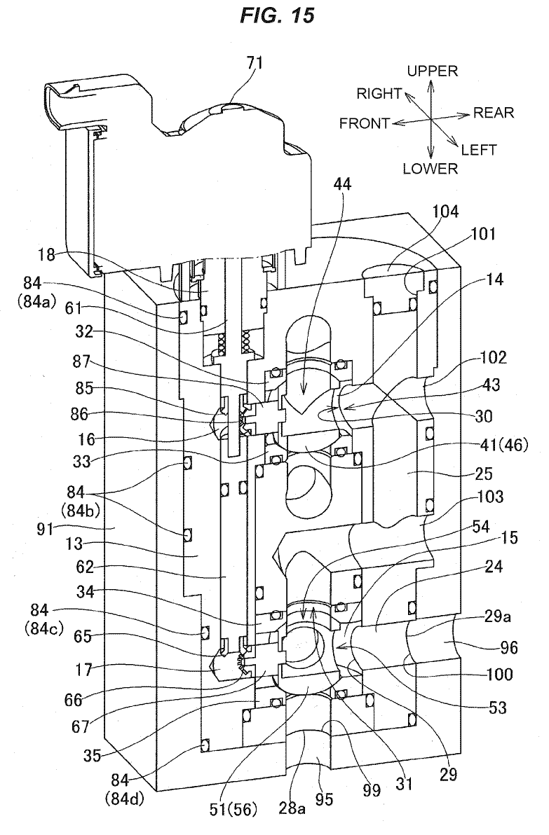

Further, the valve main body 13 has a columnar entire shape as is different from the first embodiment. Further, in addition to the outer openings 26a to 29a, an opening 101 is formed in an upper surface of the valve main body 13, and two openings 102 and 103 are formed in a rear side of the outer peripheral surface of the valve main body 13, respectively (refer to FIGS. 14 and 15). However, these holes 101 to 103 are formed when piercing the communication flow passage 25, for example, by a drill, and may be appropriately closed, for example, by a plug-like member 104 (not shown for the openings 102 and 103 in the rear side of the outer peripheral surface).

The housing 91 has an inflow passage 96 (corresponding to “fourth flow passage” according to the present invention) which allows the refrigerant to flow into, and three outflow passages (a first outflow passage 93, a second outflow passage 94 and a third outflow passage 95) which allows the refrigerant to flow out. The first outflow passage 93, the second outflow passage 94 and the third outflow passage 95 respectively correspond to “first flow passage”, “second flow passage” and “third flow passage” according to the present invention. Further, as an end part opening which is open to an inner surface of the valve mounting hole 92, the inflow passage 96 has an inflow port 100, the first outflow passage 93 has a first outflow port 97, the second outflow passage 94 has a second outflow port 98, and the third outflow passage 95 has a third outflow port 99, respectively. By inserting the electrically operated valve 81 into the valve mounting hole 92, the first outer opening 26a faces the first outflow port 97, the second outer opening 27 faces the second outflow port 98, the third outer opening 28a faces the third outflow port 99, and the fourth outer opening 29a faces the inflow port 100, respectively, thereby communicating the first outflow hole 21 with the first outflow passage 93, communicating the second outflow hole 22 with the second outflow passage 94, communicating the third outflow hole 23 with the third outflow passage 95, and communicating the inflow hole 24 with the inflow passage 96 respectively.

Further, the present embodiment is provided with the similar mechanism to the mechanism for transmitting the rotation from the second valve body drive shaft 62 to the second valve body 51, for vertically rotating the first valve body 41.

In particular, a first driving side bevel gear 85 is disposed in a lower end part of the first valve body drive shaft 61 (an upper portion of a connection part to the second valve body drive shaft 62), and a first valve body driven shaft 87 is provided. The first valve body driven shaft 87 has in one end (a front end) thereof a first driven side bevel gear 86 engaging with the first driving side bevel gear 85 and extends horizontally in the upper part of the valve main body 13. The other end (a rear end) of the first valve body driven shaft 87 is connected to the first valve body 41, in more detail, to the shell wall part 46 in the front side of the first valve body 41 which is an opposite side to the first opening part 43 formed in the rear side of the first valve body 41.

A mechanism for transmitting the rotation from the second valve body drive shaft 62 to the second valve body 51 is the same as the first embodiment. In the present embodiment, in order to distinguish from the transmission mechanism (the first driving side bevel gear 85 and the first driven side bevel gear 86) to the first valve body 41, the driving side bevel gear 65 and the driven side bevel gear 66 in the first embodiment are respectively called as “second driving side bevel gear” and “second driven side bevel gear”.

According to the transmission mechanism as mentioned above, the rotation generated by the rotation of the first valve body drive shaft 61 is transmitted to the first valve body driven shaft 87 via the first driving side bevel gear 85 and the first driven side bevel gear 86, and the first valve body 41 vertically rotates. At the same time, the second valve body drive shaft 62 connected to the first valve body drive shaft 61 also rotates, and the rotation is transmitted to the second valve body driven shaft 67 via the second driving side bevel gear 65 and the second driven side bevel gear 66, so that the second valve body 51 vertically rotates. The first driving side bevel gear 85 and the first driven side bevel gear 86 transmitting the rotation of the first valve body drive shaft 61 to the first valve body driven shaft 87 correspond to “first engagement means” according to the second aspect of the present invention, and the second driving side bevel gear 65 and the second driven side bevel gear 66 transmitting the rotation of the second valve body drive shaft 62 to the second valve body driven shaft 67 correspond to “second engagement means” according to the second aspect of the present invention.

Further, each of the gear ratios of the first engagement means (the first driving side bevel gear 85 and the first driven side bevel gear 86) and the second engagement means (the second driving side bevel gear 65 and the second driven side bevel gear 66) is set such that the rotating speed of the second valve body 51 comes to one half of the rotating speed of the first valve body 41, that is, the second valve body 51 rotates at 90 degrees when the first valve body 41 rotates at 180 degrees.

A description will be given of a motion of the electrically operated valve 81 according to the present embodiment on the basis of FIGS. 18 to 20. In the present embodiment, the first outer opening 26a (the first outflow hole 21) and the second outer opening 27a (the second outflow hole 22) are open to the right side of the outer peripheral surface of the valve main body 13, the fourth outer opening 29a (the inflow hole 24) is open to the rear side of the outer peripheral surface of the valve main body 13, and the axis lines of the first outer opening 26a and the second outer opening 27a are orthogonal to the axis line of the fourth outer opening 29a. However, for convenience of illustration (in order to easily understand conceptually) in the same manner as FIGS. 10 to 12 mentioned above, in FIGS. 18 to 20 conceptually showing the electrically operated valve 81 according to the present embodiment, the axis lines of the first outer opening 26a and the second outer opening 27a are expressed in the drawings to be parallel to the axis line of the fourth outer opening 29a.

### [First Switched State]

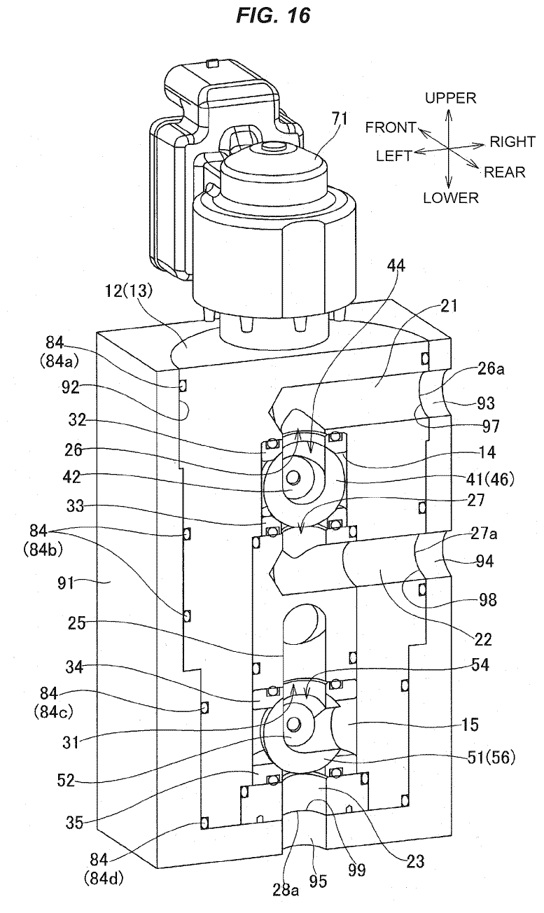

In a first switched state (FIGS. 15 and 16 also show the first switched state) shown in FIG. 18, the fourth opening part 54 (refer also to FIG. 6) of the second valve body 51 faces the sixth inner opening 31 of the communication flow passage 25, and the second opening part 44 of the first valve body 41 faces the first inner opening 26 of the first outflow hole 21. At this time, the third inner opening 28 of the second valve chamber 15 (the third outflow hole 23) is closed by the shell wall part 56 of the second valve body 51, and the second inner opening 27 of the first valve chamber 14 (the second outflow hole 22) is closed by the shell wall part 46 of the first valve body 41. Further, the third opening part 53 of the second valve body 51 always faces the inflow hole 24 (the fourth inner opening 29), and the first opening part 43 of the first valve body 41 always faces the fifth inner opening 30 of the communication flow passage 25.

Therefore, in this first switched state, the refrigerant flowing into the second valve chamber 15 from the inflow hole 24 flows into the second valve body inner space 52 through the third opening part 53, flows out to the communication flow passage 25 from the second valve body inner space 52 through the fourth opening part 54 and the sixth inner opening 31, and flows forward in the communication flow passage 25. Further, the refrigerant flows into the first valve body inner space 42 through the fifth inner opening 30 of the communication flow passage 25 and the first opening part 43 of the first valve body 41, thereafter flows out to the first outflow hole 21 through the second opening part 44, and flows out of the valve through the first outflow hole 21.

### [Second Switched State]

A second switched state shown in FIG. 19 is a state in which the first valve body drive shaft 61 and the second valve body drive shaft 62 connected to the first valve body drive shaft 61 are rotated from the first switched state by the driving apparatus 71, and the first valve body 41 is vertically rotated at 180 degrees. When the first valve body 41 vertically rotates at 180 degrees, the second valve body 51 vertically rotates at 90 degrees.

In this second switched state, the fifth opening part 55 of the second valve body 51 faces the sixth inner opening 31 of the communication flow passage 25, and the second opening part 44 of the first valve body 41 faces the second inner opening 27 of the second outflow hole 22. At this time, the third inner opening 28 of the second valve chamber 15 (the third outflow hole 23) is closed by the shell wall part 56 of the second valve body 51, and the first inner opening 26 of the first valve chamber 14 (the first outflow hole 21) is closed by the shell wall part 46 of the first valve body 41.

Therefore, in this second switched state, the refrigerant flowing into the second valve chamber 15 from the inflow hole 24 flows into the second valve body inner space 52 through the third opening part 53, flows out to the communication flow passage 25 from the second valve body inner space 52 through the fifth opening part 55 and the sixth inner opening 31, and flows forward in the communication flow passage. Further, the refrigerant flows into the first valve body inner space 42 through the fifth inner opening 30 of the communication flow passage 25 and the first opening part 43 of the first valve body 41, thereafter flows out to the second outflow hole 22 through the second opening part 44, and flows out of the valve through the second outflow hole 22.

### [Third Switched State]

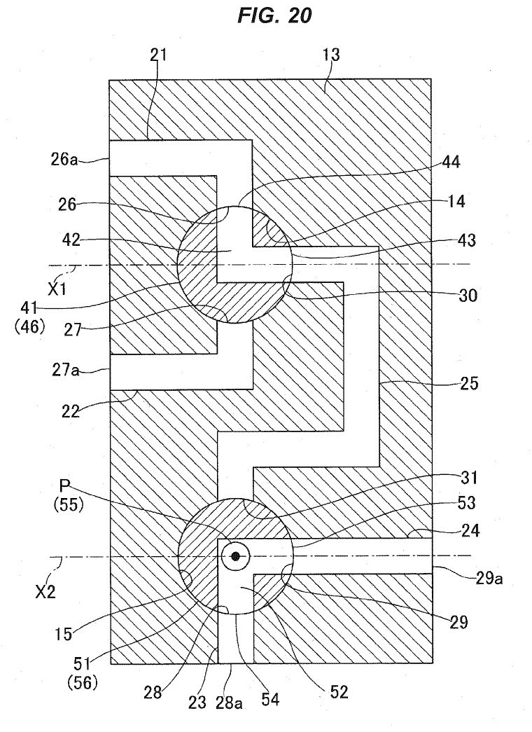

A third switched state shown in FIG. 20 is a state in which the first valve body drive shaft 61 is further rotated in the same direction from the second switched state by the driving apparatus 71, and the first valve body 41 is vertically rotated at 180 degrees. When the first valve body 41 vertically rotates at 180 degrees, the second valve body 51 vertically rotates at 90 degrees.

In this third switched state, the fourth opening part 54 of the second valve body 51 faces the third inner opening 28 of the third outflow hole 23. The second opening part 44 of the first valve body 41 faces the first inner opening 26 of the first outflow hole 21, however, the sixth inner opening 31 of the second valve chamber 15 (the communication flow passage 25) is closed by the shell wall part 56 of the second valve body 51. Therefore, the refrigerant does not flow to the first valve chamber 14 (the communication flow passage 25).

Therefore, in this third switched state, the refrigerant flowing into the second valve chamber 15 from the inflow hole 24 flows into the second valve body inner space 52 through the third opening part 53, and thereafter flows out of the valve from the third outflow hole 23 through the third inner opening 28 in the bottom surface of the second valve chamber without flowing forward to the communication flow passage 25.

Further, it is possible to return to the second switched state by reverse rotating the first valve body drive shaft 61 from the third switched state and vertically rotating the first valve body 41 inversely at 180 degrees. Further, it is possible to return to the first switched state by reverse rotating the first valve body drive shaft 61 from the second switched state and vertically rotating the first valve body 41 inversely at 180 degrees.

Further, in the description of the first embodiment and the second embodiment, the case that the embodiments are used in the first use mode which is a typical use example is described. However, the electrically operated valves 11 and 81 can be used in a second use mode which is an inverse flow thereto. In a case where each of the electrically operated valves 11 and 81 is used in this second use mode, the first outflow hole 21, the second outflow hole 22 and the third outflow hole 23 come to the inflow holes for allowing the refrigerant to flow into the first valve body inner space 42 or the second valve body inner space 52, and the inflow hole 24 comes to the outflow hole for allowing the refrigerant to flow out of the second valve body inner space 52.

### REFERENCE SIGNS LIST

A axis of rotation of first valve body drive shaft and rotor
F1, F2, F3 flow of fluid
X, X2 axis of rotation of second valve body
Y, X1 axis of rotation of first valve body
11, 81 electrically operated valve
12 valve part
13 valve main body
14 first valve chamber
15 second valve chamber
16 first gear chamber
17 second gear chamber
18 connection member
18a guide hole
21 first outflow hole
22 second outflow hole
23 third outflow hole
24 inflow hole
25 communication flow passage
26 first inner opening
26a first outer opening
27 second inner opening
27a second outer opening
28 third inner opening
28a third outer opening
29 fourth inner opening
29a fourth outer opening
30 fifth inner opening
31 sixth inner opening
32, 33, 34, 35 valve seat ember
41 first valve body
42 first valve body inner space
43 first opening part
44 second opening part
45 top surface part
46, 56 shell wall part
51 second valve body
52 second valve body inner space
53 third opening part
54 fourth opening part
55 fifth opening part
61 first valve body drive shaft
62 second valve body drive shaft
63 driving side spur gear
64 driven side spur gear
65 driving side bevel gear
66 driven side bevel gear
67 second valve body driven shaft
71 driving apparatus (electric motor)
72 stepping motor
73 stator
74 rotor
75 speed reduction mechanism (paradox planetary gear speed reduction mechanism)
76 yoke
77 coil
78 can
79 base member
80 resin molded cover
84, 84a, 84b, 84c, 84d seal material
85 first driving side bevel gear
86 first driven side bevel gear
87 first valve body driven shaft
88a, 88b, 88c, 88d groove for placing seal material
91 housing
92 valve mounting hole
93 first outflow passage
94 second outflow passage
95 third outflow passage
96 inflow passage
97 first outflow port
98 second outflow port
99 third outflow port
100 inflow hole
101, 102, 103 opening (hole)
104 plug-like member

1. An electrically operated valve comprising:
a valve main body which has a first valve chamber and a second valve chamber in an inner part thereof;
a first valve body which has a first valve body inner space in an inner part thereof and switches a flow passage for fluid by being rotationally driven within the first valve chamber;
a second valve body which has a second valve body inner space in an inner part thereof and switches a flow passage for fluid by being rotationally driven within the second valve chamber; and
a transmission mechanism which transmits a drive force for rotating the first valve body and the second valve body to the first valve body and the second valve body,
wherein the valve main body comprises:
a first flow passage hole which allows a communication state with the first valve body inner space to be changed by a rotational displacement position of the first valve body, and communicates with the first valve body inner space at a first rotational displacement position of the first valve body;
a second flow passage hole which allows a communication state with the first valve body inner space to be changed by the rotational displacement position of the first valve body, and communicates with the first valve body inner space at a second rotational displacement position of the first valve body;
a communication flow passage which communicates with the first valve body inner space, allows a communication state with the second valve body inner space to be changed by a rotational displacement position of the second valve body, communicates with the second valve body inner space at each of the first rotational displacement position and the second rotational displacement position of the second valve body, and allows the fluid to pass through between the first valve body inner space and the second valve body inner space;
a third flow passage hole which allows a communication state with the second valve body inner space to be changed by the rotational displacement position of the second valve body, and communicates with the second valve body inner space at a third rotational displacement position of the second valve body; and
a fourth flow passage hole which communicates with the second valve body inner space.

2. The electrically operated valve according to claim 1, wherein the transmission mechanism comprises:
a first valve body drive shaft which transmits a drive force driving the first body to the first valve body; and
a second valve body drive shaft which transmits a drive force driving the second valve body to the second valve body,
wherein the drive force driving the second valve body is transmitted to the second valve body drive shaft via the first valve body drive shaft, and
wherein the first valve body and the second valve body simultaneously rotate in conjunction with each other.

3. The electrically operated valve according to claim 2, wherein on the assumption that a parallel direction to an axial direction of the valve main body and an axis line of the valve main body is a vertical direction, and an orthogonal direction to the vertical direction is a horizontal direction, the first valve body drive shaft and the axis of rotation of the first valve body both extend in the vertical direction, the second valve body drive shaft extends in the vertical direction, the axis of rotation of the second valve body extends in the horizontal direction, and
wherein the transmission mechanism comprises:
a first engagement means which transmits the rotation of the first valve body drive shaft to the second valve body drive shaft;
a second valve body driven shaft which extends in the horizontal direction, rotates by receiving a drive force transmitted from the second valve body drive shaft and transmits the rotation to the second valve body; and
a second engagement means which transmits the rotation of the second valve body drive shaft to the second valve body driven shaft.

4. The electrically operated valve according to claim 3, wherein the first engagement means comprises:
a driving side spur gear which is disposed in the first valve body drive shaft; and
a driven side spur gear which is disposed in the second valve body drive shaft and engages with the driving side spur gear, and
wherein the second engagement means comprises:
a driving side bevel gear which is disposed in the second valve body drive shaft; and
a driven side bevel gear which is disposed in the second valve body driven shaft and engages with the driving side bevel gear.

5. The electrically operated valve according to claim 3, wherein the first flow passage hole has a first inner opening which is an end part opening in the first valve chamber side,
wherein the second flow passage hole has a second inner opening which is an end part opening in the first valve chamber side,
wherein the third flow passage hole has a third inner opening which is an end part opening in the second valve chamber side,
wherein the fourth flow passage hole has a fourth inner opening which is an end part opening in the second valve chamber side,
wherein the communication flow passage has a fifth inner opening which is an end part opening in the first valve chamber side, and a sixth inner opening which is an end part opening in the second valve chamber side,
wherein an axis line of the fifth inner opening coincides with an axis of rotation of the first valve body,
wherein the first inner opening is formed in a first peripheral position around an axis line of the fifth inner opening,
wherein the second inner opening is formed in a second peripheral position around the axis line of the fifth inner opening,
wherein the fourth inner opening is formed in a side surface of the second valve chamber,
wherein an axis line of the fourth inner opening coincides with an axis of rotation of the second valve body,
wherein the sixth inner opening is formed in a first peripheral position around the axis line of the fourth inner opening,
wherein the third inner opening is formed in a second peripheral position around the axis line of the fourth inner opening,
wherein the first valve body has a first opening part which faces the fifth inner opening and communicates the communication flow passage and the first valve body inner space, and a second opening part which communicates the first flow passage hole and the first valve body inner space when facing the first inner opening, and communicates the second flow passage hole and the first valve body inner space when facing the second inner opening, in association with the rotation of the first valve body, and
wherein the second valve body has a third opening part which faces the fourth inner opening and communicates the fourth flow passage hole and the second valve body inner space, and a fourth opening part and a fifth opening part which communicates the communication flow passage and the second valve body inner space when facing the sixth inner opening and communicates the third passage hole and the second valve body inner space when facing the third inner opening, in association with the rotation of the second valve body.

6. The electrically operated valve according to claim 2, wherein on the assumption that a parallel direction to an axial direction of the valve main body and an axis line of the valve main body is a vertical direction, and an orthogonal direction to the vertical direction is a horizontal direction, the first valve body drive shaft and the second valve body drive shaft both extend in the vertical direction, the axis of rotation of the first valve body and the axis of rotation of the second valve body both extend in the horizontal direction, and
wherein the transmission mechanism comprises:
a first valve body driven shaft which extends in the horizontal direction, rotates receiving a drive force transmitted from the first valve body drive shaft and transmits the rotation to the first valve body;
a first engagement means which transmits the rotation of the first valve body drive shaft to the first valve body driven shaft;
a second valve body driven shaft which extends in the horizontal direction, rotates by receiving a drive force transmitted from the second valve body drive shaft and transmits the rotation to the second valve body; and
a second engagement means which transmits the rotation of the second valve body drive shaft to the second valve body driven shaft.

7. The electrically operated valve according to claim 6, wherein the first engagement means comprises:
a first driving side bevel gear which is disposed in the first valve body drive shaft; and
a first driven side bevel gear which is disposed in the first valve body driven shaft and engages with the first driving side bevel gear, and
wherein the second engagement means comprises:
a second driving side bevel gear which is disposed in the second valve body drive shaft; and
a second driven side bevel gear which is disposed in the second valve body driven shaft and engages with the second driving side bevel gear.

8. The electrically operated valve according to claim 6, wherein on the assumption that one side of the vertical direction is upper, and the other side of the vertical direction is lower, the first flow passage hole comprises:
a first inner opening which is an end part opening in the first valve chamber side; and
a first outer opening which is an end part opening in an opposite side to the first valve chamber,
wherein the second flow passage hole comprises:
a second inner opening which is an end part opening in the first valve chamber side; and
a second outer opening which is an end part opening in an opposite side to the first valve chamber,
wherein the third flow passage hole comprises:
a third inner opening which is an end part opening in the second valve chamber side; and
a third outer opening which is an end part opening in an opposite side to the second valve chamber,
wherein the fourth flow passage hole comprises:
a fourth inner opening which is an end part opening in the second valve chamber side; and
a fourth outer opening which is an end part opening in an opposite side to the second valve chamber,
wherein the communication flow passage comprises:
a fifth inner opening which is an end part opening in the first valve chamber side; and
a sixth inner opening which is an end part opening in the second valve chamber side,
wherein an axis line of the fifth inner opening coincides with an axis of rotation of the first valve body,
wherein the first inner opening is formed in a first peripheral position around an axis line of the fifth inner opening,
wherein the second inner opening is formed in a second peripheral position around the axis line of the fifth inner opening,
wherein the fourth inner opening is formed in a side surface of the second valve chamber,
wherein the axis line of the fourth inner opening coincides with the axis of rotation of the second valve body,
wherein the sixth inner opening is formed in a first peripheral position around the axis line of the fourth inner opening,
wherein the third inner opening is formed in a second peripheral position around the axis line of the fourth inner opening,
wherein the fourth outer opening is formed in an outer peripheral surface of the valve main body,
wherein the second outer opening is formed at a position above the fourth outer opening in the outer peripheral surface of the valve main body,
wherein the first outer opening is formed at a position above the second outer opening in the outer peripheral surface of the valve main body,
wherein the third outer opening is formed in a bottom surface or an outer peripheral surface of the valve main body at a position below the fourth outer opening,
wherein the first valve body comprises:
a first opening part which faces the fifth inner opening and communicates the communication flow passage and the first valve body inner space; and
a second opening part which communicates the first flow passage hole and the first valve body inner space when facing the first inner opening, and communicates the second flow passage hole and the first valve body inner space when facing the second inner opening, in association with the rotation of the first valve body, and
wherein the second valve body comprises:
a third opening part which faces the fourth inner opening and communicates the fourth flow passage hole and the second valve body inner space; and
a fourth opening part and a fifth opening part which communicate the communication flow passage and the second valve body inner space when facing the sixth inner opening, and communicate the third flow passage hole and the second valve body inner space when facing the third inner opening, in association with the rotation of the second valve body.

9. The electrically operated valve according to claim 6, wherein the electrically operated valve is mountable to a housing by inserting into a valve mounting hole of the housing provided with the valve mounting hole, a fourth flow passage which has an end part opening in an inner peripheral surface of the valve mounting hole, a first flow passage which has an end part opening at a position above the end part opening of the fourth flow passage in the inner peripheral surface of the valve mounting hole, a second flow passage which has an end part opening at a position above the end part opening of the fourth flow passage and below the end part opening of the first outflow passage in the inner peripheral surface of the valve mounting hole, and a third flow passage which has an end part opening at a position below the end part opening of the fourth flow passage in the inner peripheral surface of the valve mounting hole or in a bottom surface of the valve mounting hole, and
wherein the first flow passage hole communicates with the first flow passage of the housing, the second flow passage hole communicates with the second flow passage of the housing, the third flow passage hole communicates with the third flow passage of the housing, and the fourth flow passage hole communicates with the fourth flow passage of the housing, when the valve main body is inserted into the valve mounting hole.
